(19) United States
(12) Patent Application Publication
(10) Pub. No.: US 2013/0191207 A1
(43) Pub. Date: Jul. 25, 2013

(54) CROSS-MEDIUM ADVERTISING NETWORK

(71) Applicants: Bradley Hopkins Smallwood, Palo Alto, CA (US); Kurt Dodge Runke, Los Altos, CA (US); Gokul Rajaram, Los Altos, CA (US)

(72) Inventors: Bradley Hopkins Smallwood, Palo Alto, CA (US); Kurt Dodge Runke, Los Altos, CA (US); Gokul Rajaram, Los Altos, CA (US)

(21) Appl. No.: 13/354,849

(22) Filed: Jan. 20, 2012

(51) Int. Cl. G06Q 30/02

(52) U.S. Cl. 705/14.41

(57) ABSTRACT

An online advertising system receives ads and ad exposure goals, such as a desired number of impressions or amount of presentation time, from advertisers. The online advertising system may also receive a time-based advertising purchase. A request for an ad is received for a client, and an amount of exposure is determined for each received ad across a plurality of ad mediums. The ad mediums may include both controlled ad mediums and external ad mediums. The advertising system selects an ad for presentation among the received ads based on the received ad exposure goals associated with the ads and the determined amount of exposure for each ad. The advertising system may select an ad by determining bids for each ad and conducting an auction among the ads. In such an embodiment, the advertising system may determine the bids for ads that have met their ad exposure goals to be zero.

### CROSS-REFERENCE TO RELATED APPLICATION

This application is related to U.S. patent application Ser. No. 13/354,785, titled “Pricing and Delivery of Advertising Based on Exposure Time,” filed on Jan. 20, 2012, which is incorporated by reference herein in its entirety.

### BACKGROUND

This invention relates to a cross-medium advertising network, and more particularly to selecting an ad for display to a target user based on ad exposure across a plurality of ad mediums, and based on an advertiser's ad exposure goals, such as a desired total amount of exposure time for a given ad.

Online services, such as social networking systems, search engines, news aggregators, Internet shopping services, and content delivery services, have become a popular venue for presenting advertisements to prospective buyers. Some online services provide their services free of charge or charge only minimal fees. Instead, the online services generate revenue by presenting advertisements (“ads”) to users, who may take certain actions based on the presented ads (e.g., clicking of the ads). The ad-based online service model has spawned many diverse types of online services.

Online services often use a scheme that charges ad fees commensurate with the number of times the ads are displayed to the users (i.e., “impressions”) or based on actions taken by the users in response to viewing the ads (such as clicks or conversions). The pricing structure widely used in online services for assessing ad fees includes, for example, Cost Per Impression (CPI) and Cost Per Action (CPA). The CPI-based pricing structure assesses ad fees based on the number of instances an ad is loaded and displayed on a user's screen, typically in response to a user's request for a content item. The CPA-based pricing structure assesses ad fees based on actions taken by the users after the ads are displayed on the screen. The actions taken into account for the CPA-based pricing structure may include, among others, (i) clicking on the ad, (ii) registration to the advertiser's service or product, and (iii) conclusion of a sale of a service or product. Rather than using CPI or CPA-based pricing structures, some online services charge a flat fee for displaying an ad.

In addition to online ad display, ads may be displayed or otherwise presented to a user via alternative ad mediums. For instance, ads may be displayed on television, over the radio, on billboards, in magazines, on mobile devices, or within any other suitable ad mediums. The display or presentation of an ad to one or more users is referred to herein as the “exposure” of the ad. Information about ad exposure may be leveraged by advertisers for ad bidding, by an ad server for selecting an ad, or for any other suitable purpose. However, the use of information about ad exposure is limited to the information about ad exposure across a single, controlled ad medium, limiting the utility of such information. Presenting an ad includes any method of exposing the ad to the user, such as by displaying the ad, playing the ad, and the like. Although an ad may be presented to a user in ways other than by display (for example, an audio ad may be played to the user over the radio), the remainder of the description will refer to the display of ads only for the purposes of simplicity. It should be noted, however, that the principles described herein apply equally to ads which are not presented by display.

### SUMMARY

Embodiments of the invention select an ad among a plurality of ads based on ad exposure goals and determined amounts of ad exposure. An ad and associated ad exposure goals are received from one or more advertisers. The ads may be text ads, image ads, video ads, and the like. The ad exposure goals may be a desired amount of ad display time or a desired number of ad impressions. In addition to ads and ad exposure goals, advertisers may provide time-based advertising purchases, time-based ad bids, and ad budgets.

In one embodiment, a request for an ad is received from a client. The request for an ad may be in the form of a request for content, of which an ad is a component. In response to receiving a request for an ad, an amount of exposure for each ad is determined. The determined amount of exposure for an ad may be the amount of display time for the ad or a number of impressions for the ad over a plurality of mediums through which the ad can be presented to the user. Ad exposure may be determined by querying the ad mediums for ad exposure information and aggregating the received ad exposure information. Ad exposure information may be aggregated based on the identity of the client associated with the ad exposure information or the type of exposure associated with the ad exposure information. Ad exposure information may also be weighted by exposure type or client identity before or during ad exposure information aggregation.

Ad exposure information may be received from both controlled ad mediums and external ad mediums. Examples of ad mediums include web pages, social networking systems, television content or services, radio content or services, billboards, magazines, and any other medium capable of presenting an ad to a user. Ad exposure on external mediums may be estimated, for instance, by monitoring the external ad mediums or by receiving ad exposure information for the external ad medium from an external source, and may be estimated on a per-user basis or on a per-group of users basis. Ad exposure for an ad is then determined by aggregating the estimated ad exposure information associated with the external ad mediums and the received ad exposure information associated with the controlled ad mediums.

An ad is then selected based on the received ad exposure goals and the determine ad exposure associated with the received ads. Ads may also be selected based on the identity of the requesting client. Ad exposure for each ad may be determined by client identity, and an ad may be selected based on the ad exposure and ad exposure goals for the identified client. The identity of the client may be determined using, for instance, a social networking system plug-in, online account information, cookie information, or any other mechanism for identifying the recipient of an ad in one or more different mediums.

In one embodiment, an ad may be selected based on ad display time rather than impressions or actions. In this embodiment, advertisers may purchase a block of ad display time or may provide bids on ad display time coupled with ad budgets. The total ad display time across one or more ad mediums may be determined, and an ad may be selected among the subset of ads that have not met the associated purchased ad display time or budgets. An auction may be conducted among the ads, and bids for each ad may be determined based on the purchased amount of display time and the anticipated amount of time for which an ad will be displayed, or based on the advertiser-provided bids.

### BRIEF DESCRIPTION OF THE DRAWINGS

FIG. 1 is a block diagram illustrating the operation of a cross-medium advertising network, according to one embodiment.

FIG. 2 is a high level block diagram of a system environment suitable for the implementation of a cross-medium advertising network, according to one embodiment.

FIG. 3 is a block diagram illustrating an ad database configured to receive ads and ad information from one or more advertisers, according to one embodiment.

FIG. 4 is a block diagram illustrating the selection and display of an ad based on a time-based ad purchase, according to one embodiment.

FIG. 5 is a block diagram illustrating the selection and display of an ad based on ad exposure information, according to one embodiment.

FIG. 6 is a flowchart illustrating the selection of an ad for display based on a time-based ad purchase, according to one embodiment.

FIG. 7 is a flowchart illustrating the selection of an ad based on ad exposure information, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

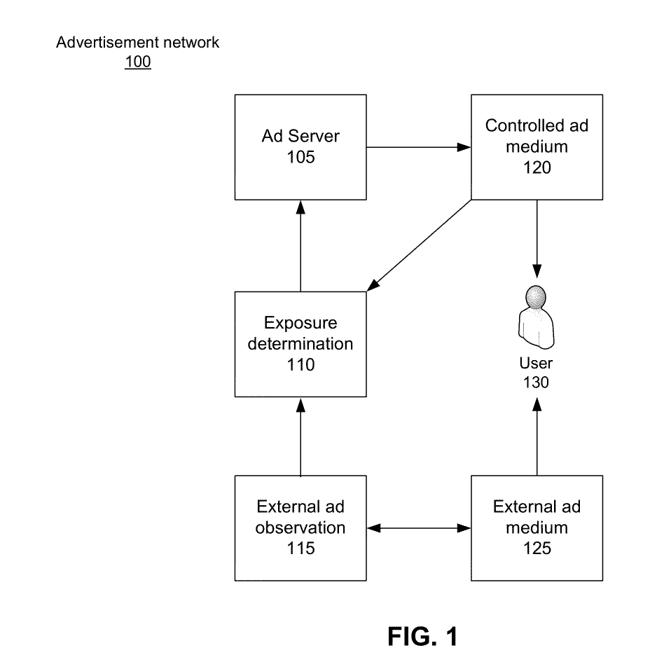

FIG. 1 is a block diagram illustrating the operation of a cross-medium advertising network, according to one embodiment. The embodiment of FIG. 1 includes an ad server 105, an exposure determination module 110, an external advertising observation module 115, a controlled advertising medium 120, and an external advertising medium 125. The controlled advertising medium 120 and the external advertising medium 125 display ads to the user 130. Although only a single controlled ad medium 120, a single external ad medium 125, and a single user 130 are shown in FIG. 1, other embodiments may have any number of ad mediums and/or users, for instance hundreds or thousands of either.

The ad server 105 selects an ad and sends the selected ad to the controlled ad medium 120 for display to the user 130. As used herein, “controlled ad medium” is used to describe any ad medium that retrieves ads from the ad server 105 for display to the user 130. Ads are also displayed to the user 130 on the external ad medium 125. As used herein, “external ad medium” is used to describe any ad medium that retrieves ads from a source other than the ad server 105.

The ad server 105 selects an ad for display based on, among other factors, ad exposure information collected by the exposure determination module 110. The exposure determination module 110 receives ad exposure information from, among other sources, the controlled ad medium 120. In one embodiment, the controlled ad medium 120 transmits the ads that are displayed to the user 130 to the exposure determination module 110. Alternatively, either the ad server 105 or the controlled ad medium 120 may identify displayed ads to the exposure determination module 110. In addition, the controlled ad medium 120 may send other exposure information related to the display of the ads to the user 130 to the exposure determination module 110.

Examples of exposure information include but are not limited to the identity of the ad displayed to the user 130, the number of times the ad was displayed to the user 130 (the impressions of the ad), the length of time the ad was displayed to the user 130 (often, exposure time must be estimated), the identity of or any other user information related to the user 130, any actions taken by the user 130 with regard to the displayed ad, the setting or context of the displayed ad, or any other information related to the display of the ad. Likewise, exposure information may include the total number of times the ad was displayed to all or a subset of users, the total amount of time the ad was displayed to all or a subset of users, the identity of all or a subset of users, etc.

The ad exposure information may include the total number of times an ad is displayed to all users (counting multiple ad displays to a single user), or may be limited to the number of unique users to whom an ad is displayed. The ad exposure information may limit counting the number of times an ad is displayed to a single user to a predetermined threshold, and the predetermined threshold may be set based on a determined effectiveness threshold describing the effectiveness of repeatedly displaying an ad to a user.

The ad exposure information may include the total time an ad was displayed to a user 130, limited to a predetermined threshold of time. In one embodiment, if an ad is displayed to a user 130 within a web page, and the user 130 does not navigate away from the web page for a period of time greater than the predetermined threshold of time, the ad exposure information only counts the predetermined threshold of time for the particular displaying of the ad. If an ad is displayed to a user 130 within a web page and the user navigates away from the web page in an amount of time less than the predetermined threshold of time, the ad exposure information may count the amount of time the ad was displayed to the user 130 before the user 130 navigated away from the web page. Moreover, if the user navigates away from the web page before a minimum time has elapsed, the ad exposure may not be counted for this experience. If it cannot be determined how long the user 130 was exposed to the ad, a default exposure may be assumed or the entire ad exposure may not be counted for this experience.

For ads displayed as television commercials or radio commercials, the ad exposure information may include the length of the commercials. Likewise, for such ads, if the user changes the channel or otherwise interrupts the display of the ads, the ad exposure may count only the period of time the ads were displayed to the user. For any type of ad, if a user navigates away from or otherwise interrupts the display of the ad in less than a minimum threshold amount of time (for example, 1 second or less), the ad exposure information may not include this period of time. The minimum threshold of time may be set based on a determined effectiveness threshold describing the effectiveness of displaying an ad to a user for a minimal amount of time.

The exposure determination module 110 also receives ad exposure information about ads displayed to the user 130 on the external ad medium 125. In some embodiments, the exposure determination module 110 has direct contact with the external ad medium 125, despite having no control or influence over the ad content displayed on the external ad medium 125. For example, the external ad medium 125 may directly send the identity of ads displayed to the user 130 on the external ad medium 125 and other ad exposure information to the exposure determination 110. In alternative embodiments, the exposure determination module 110 does not have direct contact with the external ad medium 125, and instead receives exposure information from the external ad observation module 115.

The external ad observation module 115 monitors the external ad medium 125 to determine exposure information related to the display of an ad to the user 130 by the external ad medium 125. The external ad observation module 115 may directly monitor the external ad medium 125. The external ad medium 125 may be a television channel, and the external ad observation module 115 may directly monitor the external ad medium 125 by analyzing the television channel's content to identify ads displayed on the television channel. Likewise, the external ad medium 125 may be a radio channel, web page, computer application, mobile application, magazine, billboard, newspaper, or the like, and the external ad observation module 115 may directly monitor the external ad medium 125 by analyzing the content on these mediums to identify ads played on the radio channel. In such embodiments, the identity of the user 130 may be determined by the ad server 105 and associated with the external ad exposure information. It may be difficult or impossible to determine the identity of the user 130 even with direct monitoring of the external ad medium 125; in such instances, a probabilistic model may be used to determine the identity of the user 130.

The external ad observation module 115 may indirectly monitor the external ad medium 125. In such an embodiment, the external ad observation module 115 may receive information about the ad content of the external ad medium 125 from a third-party source, such as from content listings, social networking systems, or from the advertisers themselves. In such embodiments, the likelihood that the user 130 viewed the ad is determined by the external ad observation module 115. The external ad observation module 115 may retrieve and use Nielsen ratings to determine the likelihood that the user 130 viewed the ad based on demographic information describing the user. For instance, if the Nielsen ratings indicate that 40% of males between the ages of 25 and 49 watched a television program that included the ad, the external ad observation module 115 may determine that there is a 40% probability that the user 130 viewed the ad if the user 130 is a 30-year-old male. Alternatively, the external ad observation module 115 may retrieve social networking system information related to the user 130 to determine if the user viewed the ad. For instance, if the user 130 indicates in a social networking system post that the user 130 used an application on a mobile device known to display the ad 20% of the time, the external ad observation module 115 may determine that there is a 20% probability that the user 130 viewed the ad. Such probabilistic models may be used to determine the identity of the user 130, or may be used to determine demographic information describing the user 130.

In one embodiment, the exposure determination module 110 and/or the external ad observation module 115 receives exposure information from the device used by the user 130 to receive and display the ad from the controlled ad medium 120 and/or the external ad medium 125. For example, the device used by the user 130 may be a TV set-top box or video game system with internet connectivity, a television with internet connectivity, a computer running a web browser, a mobile device, or the like. In such an embodiment, the device may transmit exposure information such as the identity of the user 130, the identity of the ad, the length of the time the ad was displayed to the user 130, and the like, directly to the exposure determination module 110.

In the embodiment of FIG. 1, the exposure determination module 110 receives ad exposure information from the controlled ad medium 120 and the external ad observation module 115, though in other embodiments, the exposure determination module 110 receives ad exposure information from other sources as well, such as from the ad server 105, the external ad medium 125, a device used by the user 130, or from any other source. The exposure determination module 110 may aggregate, analyze and otherwise organize this received information. In one embodiment, the exposure determination module 110 aggregates the total exposure for each ad, for each advertiser, for each ad campaign, and/or for each user 130. For example, the exposure determination module 110 may determine the total amount of exposure time for a particular ad or set of ads to a particular user, and may identify the total exposure time and the user to the ad server 105. The exposure determination module 110 transmits the received and/or aggregated or analyzed information to the ad server 105.

The exposure determination module 110 may weight ad exposure information based on the ad medium on which an ad is displayed, based on the user 130 to whom the ad is displayed, or based on any other factor. In one embodiment, the exposure determination module 110 weights ad exposure information for ads played on a television or over the radio higher than for ads displayed on a web page. For example, the exposure determination module 110 may count a television ad as five impressions and a web page ad as one impression. Similarly, the exposure determination module 110 may multiple the time an ad is played over the radio by a factor of three relative to the time an ad is displayed on a web page. The exposure determination module 110 may also weight ad impressions and display time to advertiser-targeted users higher than ad impressions and display time to non-targeted users. Finally, the exposure determination module 110 may increase the weighting of an ad displayed to the user 130 if the user 130 clicks on the ad or takes another action with regards to the ad (such as making a purchase in conjunction with the ad).

As discussed above, the ad server 105 selects an ad for transmission to the controlled ad medium 120 based at least in part on the ad exposure information received from the exposure determination module 110 (for ad exposure on, for instance, the controlled ad medium 120 and/or the external ad medium 125). In one embodiment, the ad server 105 receives from an advertiser a purchase of an amount of ad time for an ad, and selects the ad for transmission to the controlled ad medium 120 based on whether the total of amount of display time for the ad within the ad exposure information associated with the ad exceeds or falls short of the purchased amount of time for the ad. Likewise, the advertiser may purchase an amount of ad time for a set of ads, or an ad campaign, and the ad server 105 may select an ad based on whether the total amount of display time for the ad campaign or the set of ads exceeds the purchased ad time. Similarly, an advertiser may buy a number of ad impressions for one or more ads, and the ad server 105 may select an ad of the one or more ads based on whether the total number of impressions for the ad or set of ads exceeds the purchased ad time. The advertiser may also buy a combination of exposure factors for a combination of ads as part of an ad campaign, and the ad server 105 may select any of the ads based on the total exposure information for the ad campaign.

The ad server 105, in response to receiving a request for an ad, may conduct an auction among ads received from advertisers based on bids supplied by the advertisers, or based on the total budgets for ads supplied by the advertisers. In one embodiment, the ad server 105 determines a bid for each received ad (for example, the bid supplied by an advertiser, or a bid based on the budget of an advertiser for the ad), and the ad with the highest bid is selected.

In one embodiment, the advertiser may bid on or purchase a desired amount of ad exposure time based on the identity of the user 130. For example, an advertiser may bid on or purchase 2 minutes of ad exposure time for each user 130 that requests an ad, up to a set budget, for a particular ad. In such an embodiment, the ad server 105 may bid on or select the ad if the user 130 requesting an ad has been exposed to the ad (for instance, via the controlled ad medium 120 or the external ad medium 125) for less than 2 minutes and if the advertiser has remaining budget. Likewise, an advertiser may bid on or purchase 5 minutes of exposure time for each of a particular set of users for a particular ad, and the ad server 105 may only select the ad if the requesting user 130 is a member of the set of users, if the requesting user 130 has been exposed to the ad for less than 5 minutes, and if the advertiser has remaining budget.

An advertiser may purchase or bid on ad exposure on a particular controlled ad medium 120. In such an embodiment, the ad server 105 may bid on or select the ad only if the user 130 requesting an ad is requesting the ad via the particular controlled ad medium 120. An advertiser may purchase a number of ad impressions for an ad, and the ad server 105 may bid on or select the ad only if the total number of ad impressions for the ad across all users does not exceed the purchased number of ad impressions.

### System Architecture

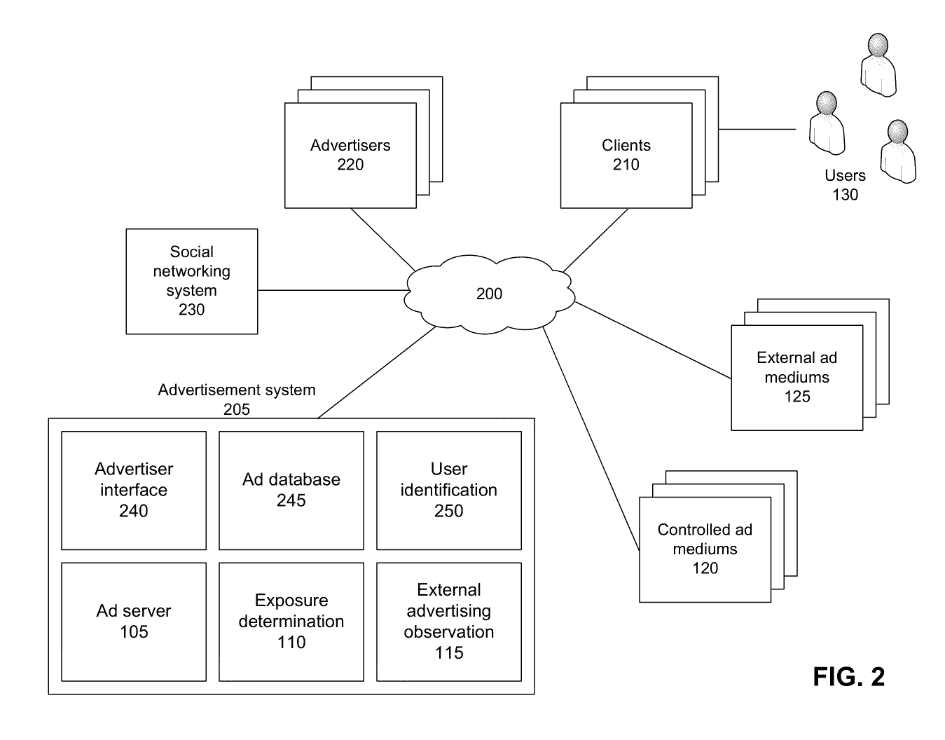

FIG. 2 is a high level block diagram of a system environment suitable for the implementation of a cross-medium advertising network, according to one embodiment. The system environment includes an advertising system 205, controlled ad mediums 120, external ad mediums 125, clients 210, advertisers 220, and a social networking system 230 that communicate through a connecting network 200. Other entities, such as external data sources, are not shown in FIG. 2, though may similarly communicate with the entities of FIG. 2. In one embodiment, various entities may be implemented in a single entity. For example, the advertisement system 205 or the controlled ad mediums 120 may be implemented within the social networking system 230.

The advertisers 220 are configured to provide ads and ad information (such as ad budgets and other constraints, ad bids, ad goals, ad formats and other characters, and other information describing the ads or set by the advertisers) to the advertisement system 205 for storage. Users 130 request an ad from the advertisement system 205 via the clients 210 and a controlled ad medium 120, and the advertisement system 205 is configured to select an ad for display to users 130 via the clients 210 through the controlled ad mediums 120. In addition to the controlled ad mediums 120, ads are displayed to the users 130 via the clients 210 through one or more external ad mediums 125. Although three users 130, three clients 210, three advertisers 220, three controlled ad mediums 120, and three external ad mediums 125 are shown in FIG. 2, other embodiments may include any number of these entities, for instance one, thousands, or millions.

The clients 210 include any device capable of sending or receiving communications and other data, such as ads, through the connecting network 200. For example, clients 210 may include a mobile phone, a laptop, a server, a database, a netbook, a tablet, a desktop computer, or a television. It should be noted that any of the advertisers 220, the social networking system 230, the advertisement system 205, the controlled ad mediums 120, and the external ad mediums 125 may also be implemented in a client 210 or similar device. In one embodiment, the same entity may be both a client 210 and an advertiser 220, though clients 210 and advertisers 220 are described separately throughout the remainder of this description for the purposes of simplicity. The clients 210 may also include any software installed and executed on a client device, such as a web browser, a game, a mobile phone app, or any other program configured to communicate via the connecting network 200.

The connecting network may be the Internet, a local area network, a wireless network, a cellular network, or any other network that allows communication between modules. The connecting network 200 may use standard communications technologies and/or protocols. In alternative configurations, different and/or additional modules can be included in the system. In addition, the connecting network 200 may include a combination of networks. For example, in the embodiment where a client 210 is a mobile phone, the connecting network 200 may include a cellular phone wireless network which interfaces with the Internet, allowing the mobile phone to connect with, for example, a social networking system's web servers.

A client 210 may request an ad through a controlled ad medium 120. As discussed above, a controlled ad medium 120 in the embodiment of FIG. 2 is any ad medium capable of retrieving ads from the advertisement system 205 and displaying the ads to the clients 210. A client 210 may request an ad explicitly. For example, a client 210 may be a computer and the controlled ad medium 120 may be a website accessed by a user 130 of the computer. In this example, the website may request an ad from the advertisement system 205 to display on the website to the user 130. Alternatively, the client 210 may request an ad inexplicitly though a controlled ad medium 120 by accessing or using a controlled ad medium 120, which in turn requests an ad from the advertisement system 205 in response being accessed or used by the controlled ad medium 120. For example, a client 210 may request access to a website, and the website may include code that, when executed, causes the website to request an ad from the advertisement system 205 for display within the website's content. A client 210 may execute a controlled ad medium 120 in the form of a software application or a game, and the application or game may request an ad from the advertisement system 205 for display to a user 130 of the client 210 within the application or game. In one embodiment, a user 130 uses a client 210 to access a social networking system page, and the social networking system 230 requests an ad from the advertisement system 205 to display to a user 130.

It should be noted that although it is typically a user 130 that causes the client 210 to request an ad from the advertisement system 205 via a controlled ad medium 120, description herein may refer to the client 210 itself requesting the ad for the purposes of brevity. In addition, it should be noted that in certain instances, a client 210 does not request an ad from the advertisement system 205. For example, certain clients such as televisions may only be configured to receive data (and not to request it). In these instances, the advertisement system 205 or any other advertisement system may simply transmit an ad to the client via the ad medium, and the client displays the ad to a user 130. Likewise, certain ad mediums such as magazines and newspapers are non-transitory; these ad mediums do not communicate via the connecting network 200, and accordingly do not request an ad from the advertisement system 205 (and therefore are external ad mediums 125). It should also be noted that in certain instances, a user 130 may request or may view an ad without the use of a client 210. For example, a billboard displaying an ad or a magazine including an ad may be viewed by a user 130 without a particular client 210.

A client 210 may also request an ad through an external ad medium 125. As discussed above, an external ad medium 125 in the embodiment of FIG. 2 is any ad medium that retrieves ads, ad information, brand information, endorsement information, or any other information related to an advertiser from a source other than the advertisement system 205 for display to the clients 210. It should be noted that a particular ad medium may act as both a controlled ad medium 120 (in instances where the ad medium retrieves ads from the advertisement system 205) and an external ad medium 125 (in instances where the ad medium retrieves ads from a source other than the advertisement system 205). As discussed above, the ad mediums may include websites or other online portals, applications, games, television or television-content portals (such as satellite television, cable television, broadcast television, television-content websites, television-content internet-streaming services, and the like), movies or other videos, radio, print (such as magazines and newspapers), digital text (such as e-reader or tablet content), mobile device applications or other portals (such as SMS messaging interfaces), email, music and music-streaming services, physical displays (such as digital and non-digital billboards, displays on buildings and other structures), or any other medium capable of displaying an ad to a user 130.

The social networking system 230 may include a web-based interface comprising a series of inter-connected pages displaying and allowing users to interact with social networking system objects and other users. The social networking system pages may display information related to social networking system users, social networking system objects, communications between users, ads, or any other information. The social networking system 230 allows users to establish connections within the social networking system (referred to herein as being “friends”). Social networking system data and actions taken by users in the social networking system 230 may be stored by the social networking system 230 for later retrieval.

It should be noted that the social networking system 230 may include both controlled ad mediums 120 and external ad mediums 125. For example, the social networking system 230 may request an ad from the advertisement system 205 for display on one or more social networking system pages to a user 130 of the social networking system. In this example, the social networking system pages displaying ads from the advertisement system 205 act as controlled ad mediums 120. Likewise, the social networking system 230 may allow users to communicate about a particular product, company, or brand, using posted messages. Similarly, users may tag a product, company, or brand in an image or other social networking system object. The social networking system 230 may then display these communications or objects to a user 130 within a social networking system page, exposing the user to the product, company, or brand without action by or ad content from the advertisement system 205. In this example, the social networking system pages act as external ad mediums 125.

Ads uploaded by the advertisers 220 to the advertising system 205 may include text, HTML-linked text, images, HTML-linked images, video, audio, Adobe Flash™, or any other digital-format. In one embodiment, ads are requested for display within controlled ad medium pages, such as web pages, social networking system pages, and the like. An ad may be displayed in a dedicated portion of a page, such as in a banner area at the top of the page, in a column at the side of the page, in any portion of a page GUI, in a pop-up window, over the top of page content, or anywhere else in a page. Ads may be displayed within dedicated portions of an application or within a game during gameplay. Ads may be displayed in dedicated pages, requiring the user to interact with or watch the ad before the user may access a page, utilize an application, or play a game. In one embodiment, ads are requested for display within video media, such as television content and the like. In this embodiment, video ads may be displayed between segments of the content as traditional commercials, or image ads may be laid over the top of the video media for a period of time.

Ads may be interacted with in a variety of ways. A viewer may merely watch, view, or listen to the ad. A viewer of the ad may click on or otherwise select an ad displayed on a page or within a game or application, and the ad may direct the viewer to a page associated with the ad. Once on the page associated with the ad, the viewer may take additional actions, such as purchasing a product or service associated with the ad, receiving information associated with the ad, and subscribing to a newsletter associated with the ad. For audio and video ads, the ads may be played by selecting a component of the ad (like a “play button”), or the ads may be automatically played within other content. Ads may include games, which a viewer may play within the context of the ad. An ad may also allow a viewer to answer a poll or question posed within the ad.

Ads may contain social networking system functionality with which a viewer may interact. For instance, ads may allow a viewer to “like” or otherwise endorse the ad by selecting a button or link associated with endorsement. Likewise, a viewer may share the ad with another social network system user, or may RSVP to an event associated with a social networking system event advertised in the ad. In addition, an ad may contain social networking system context directed to the viewer. For example, an ad may display information about a friend of the viewer within the social networking system who has taken an action associated with the subject matter of the ad.

Including social networking system functionality or context with an ad may occur in a number of ways. For example, the advertising system 205 may retrieve social functionality and context directly from the social networking system 230 and may combine the ad with the retrieved functionality or context before serving the ad to an ad medium. Embodiments selecting and providing social networking system functionality and context with an ad are described in co-pending U.S. patent application Ser. No. 12/898,662, titled “Providing Social Endorsements with Online Advertising,” filed on Oct. 5, 2010, and U.S. patent application Ser. No. 13/043,424, titled “Selecting Social Endorsement Information for an Advertisement for Display to a Viewing User,” filed on Mar. 8, 2011, the contents of which are incorporated by reference herein in their entirety. Interacting with an ad containing social networking system functionality or context may cause information about the interaction to be displayed in the viewer's social networking system profile page.

As illustrated in FIG. 2, the advertisement system 205 includes an advertiser interface 240, an ad database 245, a user identification module 250, an ad server 105, an exposure determination module 110, and an external advertising observation module 115. In one embodiment, the ad server 105, the exposure determination module 110, and the external advertising observation module 115 are the respective components from FIG. 1. In other embodiments, the advertisement system 205 includes more or fewer components, and the components may perform differing functionalities than described herein.

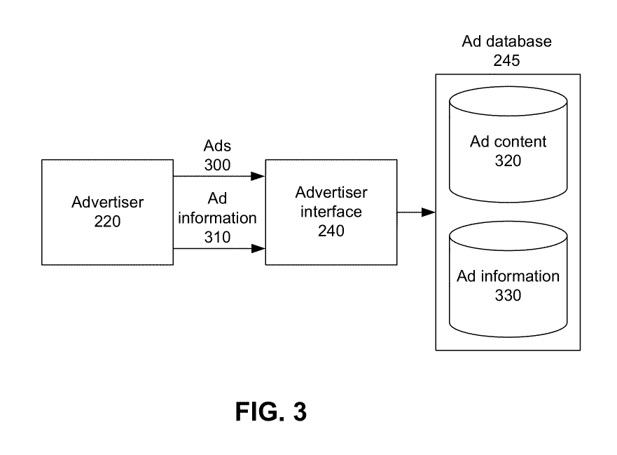

The advertiser interface 240 provides a communicative interface between the advertisement system 205 and the advertisers 220. The advertisement system 205 receives ads and associated ad information from the advertisers 220 via the advertiser interface 240, and stores the ads and ad information in the ad database 245. The advertiser interface 240 may allow the advertisers 220 to upload one or more ads, to specify ad constraints associated with the ads (such as ad budgets, maximum ad bids, desired ad contexts, etc.), to specify ad goals associated with the ads (such as desired ad exposures, desired ad audiences, etc.), and to specify any other information associated with the ads. The advertiser interface 240 may include a GUI for use by the advertisers 220. The ad database 245 stores ads and ad information received from the advertisers 220, and provides the ads and ad information to the ad server module 105 when requested. The advertiser interfaced 240 and the ad database 245 are discussed in greater detail below with regards to FIG. 3.

The user identification module 250 may identify the user 130 associated with a client 210 requesting an ad via a controlled ad medium 120, and may provide the user's identity to the ad server 105. The user 130 may be identified in a number of ways. In one embodiment, the user 130 is identified via a social networking system plug-in utilized within the controlled ad medium 120 associated with the ad request. The social networking system 130 identifies the user 130 by requiring the user 130 to sign in to the social networking system 130, and the social networking system plug-in installed at the controlled ad medium 120 relays the identity of the user 130 to the user identification module 250. Alternatively, the user 130 may be identified by requiring the user 130 to sign in to the controlled ad medium 120, by cookies installed on the client 210 associated with the user 130, by unique identifying information associated with the client 210 (such as a MAC address, a mobile device number, a serial number, a tv set-top box identifier, and the like), by email address, by IP address, or via any other method. In one embodiment, the user identification module 250 identifies the household of the user 130 instead of the user specifically, and may use demographic information to determine which member of the household the user 130 is. For example, a tv set-top box may relay to the user identification module 250 that a member of a particular house watched a particular program known to appeal to females between the ages of 10 and 17, and the user identification module 250 may identify a member of the household that is female and between the ages of 10 and 17 as the user 130.

### Advertisement Database

FIG. 3 is a block diagram illustrating an ad database configured to receive ads and ad information from one or more advertisers, according to one embodiment. The ad database 245 of FIG. 3 includes an ad content storage module 320 and an ad information storage module 330, and receives one or more ads 300 and associated ad information 310 from the advertiser 220 via the advertiser interface 240. In other embodiments, the ad database 245 includes additional or fewer storage modules and other components, for example, the ad content storage module 320 and the ad information storage module 330 may be combined into a single storage module.

The advertiser interface 240 provides the communicative interface between the advertisers 220 and the ad database 245. In one embodiment, the advertiser interface 240 is incorporated within the ad database 245. Data (such as the ads 300 and the ad information 310) sent from the advertiser 220 is routed by the advertiser interface 240 to the ad database 245. In response to receiving an ad 300 from an advertiser 220, the advertiser interface 240 may suggest budgets, ad goals, ad bids, ad campaigns, or other ad information to the advertisers 220 based on the identity of the advertiser 220, the format or content of the ad 300, or any other factor.

An advertiser 220 uploads one or more ads 300 to the ad database 245, and the ad database 245 stores the one or more ads 300 in the ad content storage module 320. The advertiser 220 also uploads ad information 310 associated with the uploaded one or more ads 300 to the ad database 245, and the ad database 245 stores the uploaded ad information 310 in the ad information storage module 330. The stored ads 300 and associated ad information 310 are stored such that the ad information 310 associated with each ad 300 is associated with the ad within the ad database 245. This beneficially allows the ad server 105 to retrieve the ad information 310 associated with an ad when the ad server 105 queries the ad database 245 for the ad.

As discussed above, the ad information 310 uploaded by an advertiser 220 may include an ad budget, a purchase of ad exposure time, one or more ad bids (on a per-impression basis, on a per-time unit of exposure basis, etc.), ad constraints (the identity of a target user or a group of users, etc.), and ad exposure goals (a number of impressions, a desired exposure time, etc.). The ad information 310 may also include information describing the ad, such as the format of the ad, the length of the ad (if the ad is playable), the dimensions of the ad, and the like. The ad information 310 may also include ad metadata associated with uploaded ads, such as the subject matter of the ads, companies or products associated with the ads, and information describing the relatedness between ads (for example, the ads associated with a particular ad campaign).

The ad database 245 may be configured to alter the format, the dimensions or other display characteristics, or the meta-data of uploaded ads as needed. The ad content storage module 320 or the ad information storage module 330 may also store social networking system functionality or context from the social networking system 230 associated with one or more stored ads 300. The ad information storage module 330 may also store historical statistics associated with stored ads, such as exposure information retrieved from the exposure determination module 110, the amount of an advertiser's budget spent on the display of particular ads, the remaining budget associated with particular ads, the amount of purchased exposure time elapsed by the display of particular ads, and the amount of remaining purchased exposure time associated with particular ads.

### Operation

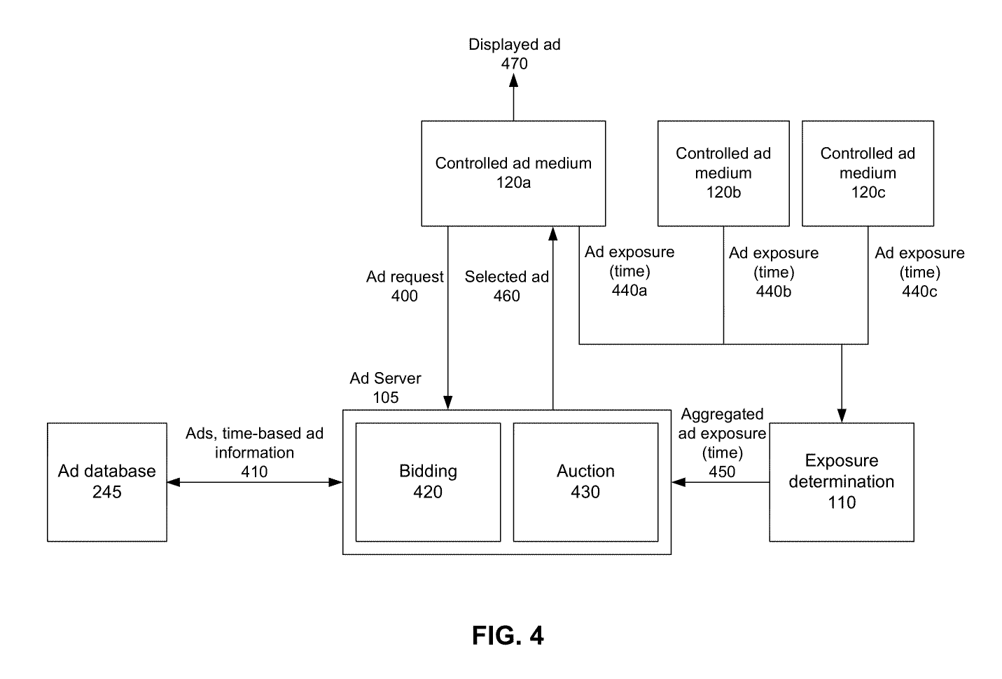

FIG. 4 is a block diagram illustrating the selection and display of an ad based on a time-based ad purchase, according to one embodiment. The embodiment of FIG. 4 includes controlled ad mediums 120a, 120b, and 120c and no external ad mediums; other embodiments may have fewer or additional controlled mediums, and may have one or more external ad mediums. In addition, in the embodiment of FIG. 4, the ad server 105 includes a bidding module 420 and an auction module 430. In other embodiments, the selection and display of an ad based on a time-based ad purchase may include additional components not shown in FIG. 4.

A controlled ad medium 120a transmits an ad request 400 to the ad server 105. The ad request 400 may be sent in response to a request for content from a user or a client to the controlled ad medium 120a. The controlled ad medium 120a may include any ad medium capable of requesting and receiving an ad from the ad server 105. For instance, the controlled ad medium 120a may be a streaming television service, and the ad request 400 may request a 30-second video commercial ad.

In response to receiving the ad request 400, the ad server 105 queries the ad database 245 for one or more suitable ads and associated time-based ad information 410. The ad sever 105 may specify a desired type of ad (for instance, an image ad, a text ad, a video ad, etc.), and may specify a genre of ad or ad subject matter based ad types and subject matter specific in the ad request 400. The time-based ad information may include, for each associated ad, an ad exposure time period purchased by an advertiser, a bid for a time period of ad exposure by an advertiser, a total amount of exposure time for previous ad displays, a budget for an ad, and the like. The ad database 245, in response to receiving the query from the ad server 105 provides one or more ads and associated time-based ad information 410 to the ad server 105.

The controlled ad mediums 120a, 120b, and 120c provide ad exposure time information 440a, 440b, and 440c, respectively, in terms of time units to the exposure determination module 110. In one embodiment, the controlled ad mediums 120 provide ad exposure time information in response to a prompt for ad exposure information from the ad server 105. Alternatively, the controlled ad mediums 120 may provide ad exposure time information 440 to the exposure determination module 110 periodically and automatically such that the exposure determination module 110 can maintain a substantially updated and current tally of the amount of exposure time for each ad in the ad database 245. To clarify, the ad exposure time information 440 includes a count or an amount of time that an ad has been displayed in the controlled ad mediums 120, for one or more ads. As discussed above, the controlled ad mediums 120 may cap reported ad exposure time information 440 for a particular ad display or to a particular user, and the controlled ad mediums 120 may weight ad exposure time information 440 based on the type or format of a particular ad, based on the user the ad is displayed to, or based on any other factor related to the ad.

The exposure determination module 110 aggregates the ad exposure time information 440 received from the controlled ad mediums 120 and sends the aggregated ad exposure time information 450 to the ad server 105. In one embodiment, aggregation includes summing the amount of ad exposure time for each ad across all controlled ad mediums 120. Thus, if a particular ad was displayed to users via the controlled ad medium 120a for 10 minutes, via the controlled ad medium 120b for 5 minutes, and via the controlled ad medium 120c for 20 minutes, the exposure determination module 110 would include a total of 35 minutes of exposure time for the ad in the aggregated ad exposure time information 450. The exposure determination module 110 may include non-time related information in the aggregated ad exposure time information 450, such as the identities of users to whom the ads have been displayed, the breakdown of ad exposure across each controlled ad medium 120, and the like. In one embodiment, the ad server 105 queries the exposure determination module 110 for the aggregated ad exposure time information 450. Alternatively, the exposure determination module 110 may periodically or automatically provide the aggregated ad exposure time information 450 to the ad server 105.

The ad server 105 receives the ads and associated time-based ad information 410 and the aggregated ad exposure time information 450, selects an ad based on this received information, and sends the selected ad 460 to the controlled ad medium 120a for display as the displayed ad 470. In the embodiment of FIG. 4, the ad server 105 conducts an auction among the received ads based on the received ad information. The bidding module 420 may determine a bid for each received ad based on a period of time that a selected ad is anticipated to be displayed. In an embodiment where advertisers make bids on ad exposure based on units of time (such as $0.50/minute), the bidding module 420 makes a bid equivalent to the advertiser-made bid if an advertiser-set budget limit has not been met, and may not make a bid if the budget limit has been met.

The bidding module 420 may determine a bid based on the purchase of a period of ad display time by an advertiser for each ad. In this embodiment, the bidding module 420 determines the bid to be the price paid by the advertiser for the purchased ad exposure time period, divided by the purchased time period and multiplied by the anticipated ad display time period. In this embodiment, the bidding module 420 determines a bid for the ad only if the received total ad exposure time has not exceeded the purchased ad exposure time period. For example, if an advertiser buys 10 minutes of ad exposure display time for an ad for $10, if the exposure determination module 110 indicates that the ad has been displayed for 7 minutes, and if the ad request 400 specifies that a 60-second ad is requested, the bidding module 420 may bid $1 for the 60-second ad.

In response to receiving a bid associated with each of one or more ads from the bidding module 420, the auction module 430 may conduct an auction among the associated ads. In one embodiment, the auction module 430 selects the ad associated with the highest bid as the selected ad 460. In other embodiments, the auction module 430 conducts an auction or selects an ad as the selected ad 460 in other suitable ways. In other embodiments, the ad server 105 selects an ad without bidding or conducting an auction, for instance by selecting an ad based on predetermined advertiser or user priorities, or based on the ad subject matter, the ad request, ad meta data, ad format or length, or any other property related to the ad, advertisers, the ad request 400, the ad server 105, and the like.

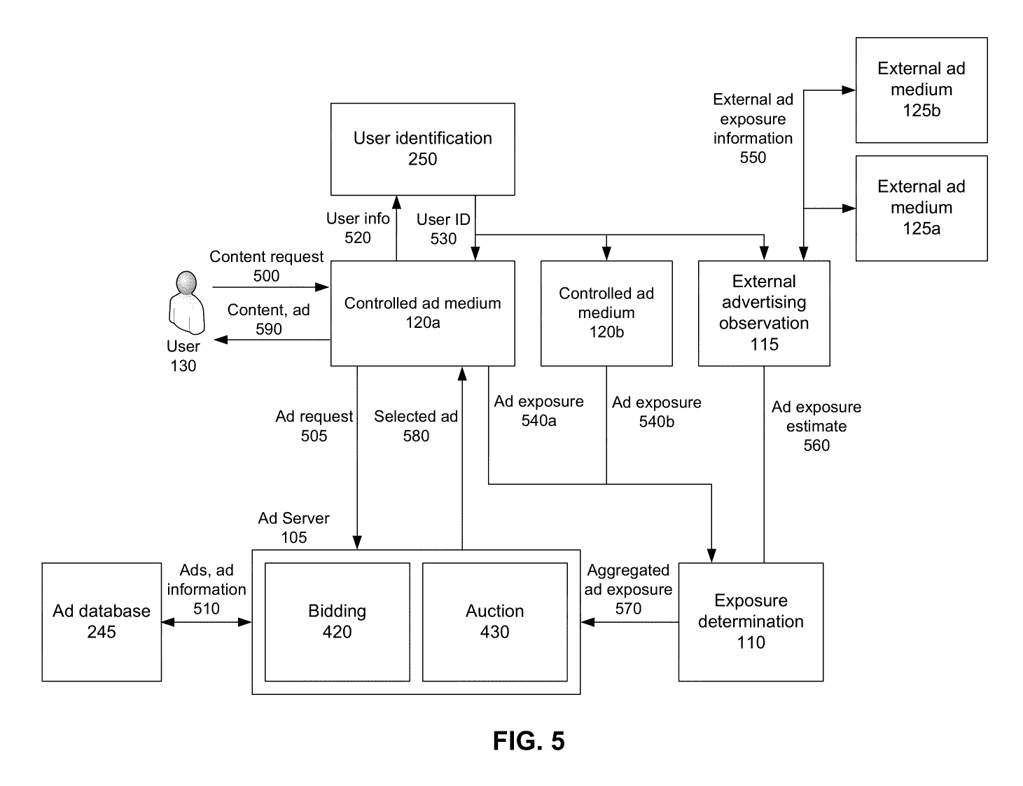

FIG. 5 is a block diagram illustrating the selection and display of an ad based on ad exposure information, according to one embodiment. The embodiment of FIG. 5 includes controlled ad mediums 120a and 120b, and external ad mediums 125a and 125b; other embodiments may have fewer or additional ad mediums. In addition, the embodiment of FIG. 5 includes a user identification module 250, an external advertising observation module 115, an exposure determination module 110, an ad database 245, and an ad server 105, which includes a bidding module 420 and an auction module 430. In other embodiments, fewer or additional components may be present.

A user 130 sends a content request 500 to the controlled ad medium 120a, for instance via a client device such as a computer, a mobile phone, or a television. The controlled ad medium 120a may be, for example, a website, a mobile application, or a television streaming service. In response to receiving the content request 500, the controlled ad medium 120a sends an ad request 505 to the ad server 105. In one embodiment, the controlled ad medium 120a requests an ad based on the identity of the user 130, based on the type of content requested, based on the controlled ad medium 120a, or based on any other information related to content or ads. Similarly to the embodiment of FIG. 4, in response to receiving the ad request 505, the ad server 105 queries the ad database 245 and receives one or more ads and associated ad information 510 in response.

The controlled ad medium 120a sends user information 520 associated with the user 130 to the user identification module 250. The user identification module 250 identifies the user 130 based on the user information 520. As described above, the user identification module 250 may identify the user 130 using a plug-in, such as a social networking system plug-in, installed or running on the controlled ad medium 120a that, in response to receiving a content request 500, identifies the user 130 to the user identification module 250. In one embodiment, the user information 520 includes demographic information, IP address or MAC address information, user credentials for the controlled ad medium 120a (such as user login information, or a user identity used to access the controlled ad medium 120a), cookie information, account information, a telephone number, a unique identifying number, or any other information associated with the user 130 that can be used by the user identification module 250 to identify or partially identify the user 130.

The user identification module 250 sends the user's identity 530 to the controlled ad mediums 120a and 120b, and to the external advertising observation module 115. Similarly to the embodiment of FIG. 4, the controlled ad mediums 120a and 120b send ad exposure information 540a and 540b to the exposure determination module 110. The external advertising observation module 115 observes the external ad mediums 125a and 125b to determine the ad exposure to the user 130 on the external ad mediums 125a and 125b. As discussed above, the external advertising observation module 115 may monitor all ads displayed to the user 130 on the external ad mediums 125a and 125b, may identify ads displayed to the user's household and may determine the likelihood that the ads were displayed to the user 130, may determine the likelihood that the ads were displayed to the user 130 based on demographic information, may identify ad exposure information based on the social networking system activity of the user 130, or may determine ad exposure based on any other information related to the user 130 or the external ad mediums 125a and 125b. The external advertising observation module 115 receives the external ad exposure information 550 from the external ad mediums 125a and 125b, estimates the total external ad exposure to the user 130, and sends the ad exposure information estimate 560 to the exposure determination module 110.

As discussed above, the ad exposure information 540a and 540b and the ad exposure information estimate 560 may include a number of total impressions for one or more ads, a number of total impressions for one or more ads for one or more particular users, an amount of time each of one or more ads has been displayed, an amount of time each of one or more ads has been displayed to one or more users, any actions taken by one or more users for one or more ads, information related to the exposure of ads in an ad campaign, or any other ad exposure information. Similar to the embodiment of FIG. 4, the exposure determination 110 aggregates the received ad exposure information 540a and 540b and the ad exposure information estimate 560 and sends the aggregated ad exposure information 570 to the ad server 105.

Similar to the embodiment of FIG. 4, the ad server 105 selects an ad based on the received ads and associated ad information 510 and/or based on the aggregated ad exposure information 570. In one embodiment, the bidding module 420 of the ad server 105 produces a bid for one or more received ads, and the auction module 430 selects the ad associated with the highest bid. The ad server 105 sends the selected ad 580 to the controlled ad medium 120a, and the controlled ad medium 120a combines the requested content with the selected ad 580 and sends the combined content and ad 590 to the user 130.

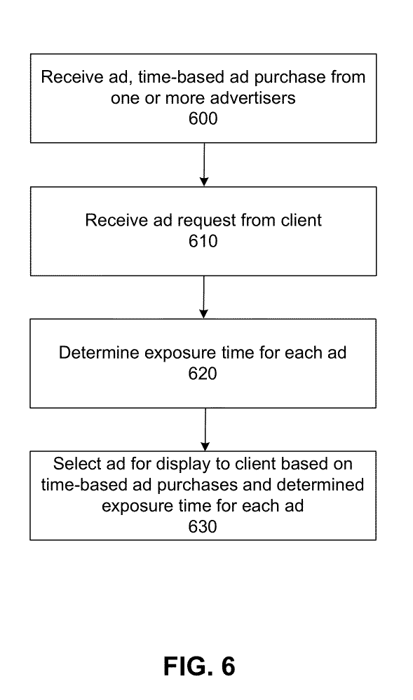

FIG. 6 is a flowchart illustrating the selection of an ad for display based on a time-based ad purchase, according to one embodiment. An ad and an associated time-based ad purchase are received 600 from each of one or more advertisers. As used herein, “time-based ad purchase” may refer to a purchase of an amount of display time for an ad, a bid on a time-unit of display time for an ad, and the like. The ads and associated time-based ad purchases may be stored for subsequent retrieval. A request for an ad is received 610 from a client. The request may be generated in response to receiving a request for content at a controlled ad medium, wherein the controlled ad medium in turn requests an ad for display with the requested content. Alternatively, the request may be received directly from the client.

For each of the one or more ads received, an amount of exposure time for the ad is determined 620. In one embodiment, the determined amount of exposure time for an ad includes the total amount of time the ad is displayed across one or more mediums. An ad is selected 630 for display among the one or more ads based on the received time-based ad purchases associated with the one or more ads and based on the determined exposure time for each of the one or more ads. For example, an auction may be conducted by determining a bid for each ad based on the received time-based ad purchases and the determined exposure time for each ad, and the ad associated with the highest bid may be selected. In this embodiment, if an ad's exposure time is equal to or exceeds the ad's time-based purchase limit, a bid may not be determined for the ad.

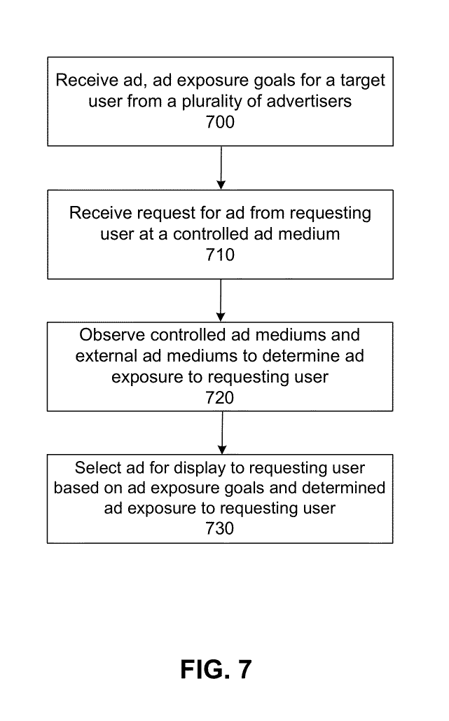

FIG. 7 is a flowchart illustrating the selection of an ad based on ad exposure information, according to one embodiment. An ad and associated ad exposure goals are received 700 from each of one or more advertisers. Ad exposure goals may include the desired amount of time for which an ad is displayed to all users, a desired amount of time for which an ad is displayed to a target user, a desired number of ad impressions for all users, a desired number of ad impressions for a target user, a desired amount of exposure time or number of ad impressions for an ad in a particular medium, a desired amount of exposure time or number of ad impressions for a particular ad setting, a desired amount of exposure time or number of ad impressions for a subset of users, a desired bid for an ad, an ad budget, and the like. The ads and associated ad exposure goals may be stored for subsequent retrieval.

A request for an ad is received 710 from a requesting user at a controlled ad medium. In one embodiment, the requesting user is identified, for instance using a social networking system plug-in, cookie information, or other unique identifying information. One or more controlled ad mediums and external ad mediums are observed 720 to determine an amount of ad exposure to the requesting user. The amount of ad exposure from each ad medium may be aggregated by ad, advertiser, ad campaign, or ad setting, and may represent the total amount of time the ad is displayed to the requesting user, the total number of impressions for the ad by the requesting user, and the like. An ad is selected 730 for display to the requesting user based on the ad exposure goals and the determined ad exposure to the requesting user. For example, an auction may be conducted, and the ad associated with a highest bid may be selected.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, at an ad system from each of one or more advertisers, an ad and associated ad exposure goals;
receiving, from a client, a request for an ad;
determining an amount of exposure of each ad, wherein the amount of exposure comprises the exposure of the ad via any of a plurality of ad mediums; and
selecting, by the ad system, an ad for presentation to the client based on the ad exposure goals associated with the ads and the determined amount of exposure for each ad.

2. The method of claim 1, wherein the received ad exposure goals comprise a threshold amount of ad presentation time.

3. The method of claim 1, wherein the received ad exposure goals comprise a threshold number of ad impressions.

4. The method of claim 1, wherein receiving a request for an ad from a client comprises receiving a request for content from the client.

5. The method of claim 1, wherein the determined amount of exposure for each ad comprises one of an amount of ad presentation time and a number of ad impressions.

6. The method of claim 1, wherein determining an amount of exposure for each ad comprises:
receiving ad exposure information from each of the plurality of ad mediums; and
aggregating the received ad exposure information to determine a total ad exposure for the ad.

7. The method of claim 6, further comprising:
aggregating the received ad exposure information based on the identity of a user to which the ads are exposed.

8. The method of claim 6, wherein aggregating the received ad exposure information comprises weighting part of the ad exposure information based on the type of ad exposure associated with the ad exposure information.

9. The method of claim 6, wherein aggregating the received ad exposure information comprises weighting part of the ad exposure information based on the identity of a user associated with the ad exposure information.

10. The method of claim 1, wherein one or more of the ad mediums comprise one or more external ad mediums, and wherein one or more of the ad mediums comprise one or more controlled ad mediums, wherein each external ad medium comprises an ad medium that receives ads from a source other than the ad system, and wherein each controlled ad medium comprises an ad medium that receives ads from the ad system.

11. The method of claim 10, wherein at least one of the controlled ad mediums comprise a web page and wherein at least one of the external ad mediums comprise television content.

12. The method of claim 10, wherein determining an amount of exposure for each ad comprises:
receiving, for the ad, ad exposure information from each of the one or more controlled ad mediums;
estimating an amount of exposure for the ad from each of the one or more external ad mediums; and
aggregating the received ad exposure information and the estimated amounts of exposure for the ad to determine a total ad exposure for the ad.

13. The method of claim 12, wherein estimating an amount of exposure for the ad from each of the external ad mediums comprises tracking the exposure for the ad on each external ad medium while monitoring the ad medium.

14. The method of claim 12, wherein estimating an amount of exposure for the ad from each of the external ad mediums comprises:
receiving information from an external source describing the contents of one or more of the external ad mediums; and
estimating an amount of exposure for the ad based on the received information.

15. The method of claim 1, wherein the received ad exposure goals associated with an ad comprise an ad exposure for the ad desired by the advertiser associated with the ad for an identified user associated with the client.

16. The method of claim 15, further comprising:
determining the identity of the user associated with the client;
determining an amount of exposure for each ad to the identified user; and
selecting an ad for presentation to the client based on the ad exposure goals associated with the ads and the determined amount of exposure for each ad to the identified user.

17. The method of claim 16, wherein determining the identity of the user comprises using a social networking system plug-in at the ad system to determine a social networking system identity for the user.

18. The method of claim 16, wherein determining the identity of the user comprises using information associated with an online account associated with the client to determine the identity of the user.

19. The method of claim 16, wherein determining the identity of the user comprises using cookie information associated with the client to determine the identity of the user.

20. A system comprising:
a receiver module configured to receive from each of one or more advertisers an ad and associated ad exposure goals, and to receive, from a client, a request for an ad;
an exposure determination module configured to determine an amount of exposure for each ad, wherein the amount of exposure comprises the exposure of the ad via any of a plurality of ad mediums; and
an ad server configured to select an ad for presentation to the client based on the ad exposure goals associated with the ads and the determined amount of exposure for each ad.
